(19) United States
(12) Patent Application Publication
(10) Pub. No.: US 2023/0100499 A1
(43) Pub. Date: Mar. 30, 2023

(54) METHOD AND APPARATUS FOR BWP OPERATION BASED ON UE TYPE IN WIRELESS COMMUNICATION SYSTEM

(71) Applicant: SAMSUNG ELECTRONICS CO., LTD., Suwon-si (KR)

(72) Inventor: Anil AGIWAL, Suwon-si (KR)

(21) Appl. No.: 17/935,858

(22) Filed: Sep. 27, 2022

(30) Foreign Application Priority Data
Sep. 27, 2021 (KR) 10-2021-0127394

(51) Int. Cl. H04W 72/04; H04W 74/08

(52) U.S. Cl. CPC H04W 72/044; H04W 74/0833

(57) ABSTRACT

The disclosure relates to a 5G or 6G communication system for supporting a higher data transmission rate. A method performed by a user equipment (UE) in a wireless communication system is provided. The method includes identifying that a random access procedure is initiated on a serving cell, selecting an uplink (UL) carrier for the serving cell, in case that physical random access channel (PRACH) occasions are not configured for an active UL bandwidth part (BWP) of the selected UL carrier, identifying whether an initial UL BWP for a reduced capability (RedCap) UE is configured, and in case that the initial UL BWP for a RedCap UE is configured, switching the active UL BWP to the initial UL BWP for the RedCap UE.

### CROSS-REFERENCE TO RELATED APPLICATION

This application is based on and claims priority under 35 U.S.C. § 119 to Korean Patent Application No. 10-2021-0127394 filed on Sep. 27, 2021, in the Korean Intellectual Property Office, the disclosure of which is incorporated by reference herein in its entirety.

### BACKGROUND

### 1. Field

The disclosure relates to a wireless communication system. Specifically, the disclosure relates to an apparatus, a method and a system for a bandwidth part (BWP) operation based on a user equipment (UE) type in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Aspects of the disclosure are to address at least the above-mentioned problems and/or disadvantages and to provide at least the advantages described below. Accordingly, an aspect of the disclosure is to provide a communication method and system for converging a 5G communication system for supporting higher data rates beyond a 4G communication system.

In accordance with an aspect of the disclosure, a method performed by a user equipment (UE) in a wireless communication system is provided. The method includes identifying that a random access procedure is initiated on a serving cell, selecting an uplink (UL) carrier for the serving cell, in case that physical random access channel (PRACH) occasions are not configured for an active UL bandwidth part (BWP) of the selected UL carrier, identifying whether an initial UL BWP for a reduced capability (RedCap) UE is configured, and in case that the initial UL BWP for the RedCap UE is configured, switching the active UL BWP to the initial UL BWP for the RedCap UE.

In accordance with another aspect of the disclosure, a UE in a wireless communication system is provided. The UE includes a transceiver and a controller operably connected to the transceiver. The controller is configured to identify that a random access procedure is initiated on a serving cell, select a UL carrier for the serving cell, in case that PRACH occasions are not configured for an active UL BWP of the selected UL carrier, identify whether an initial UL BWP for a RedCap UE is configured, and in case that the initial UL BWP for the RedCap UE is configured, switch the active UL BWP to the initial UL BWP for the RedCap UE.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a next-generation mobile communication system according to various embodiments of the present disclosure;

FIG. 2 illustrates a wireless protocol structure of the next-generation mobile communication system according to various embodiments of the present disclosure;

FIG. 3 illustrates an example of configuration a bandwidth part in a wireless communication system according to various embodiments of the present disclosure;

FIG. 4 illustrates an example of BWP switching when a random access procedure is initiated according to various embodiments of the present disclosure;

FIG. 5 illustrates an example of BWP switching when a BWP inactivity timer expires according to various embodiments of the present disclosure;

FIG. 6 illustrates a block diagram of a terminal according to various embodiments of the present disclosure; and

FIG. 7 illustrates a block diagram of a base station according to various embodiments of the present disclosure.

Throughout the drawings, like reference numerals will be understood to refer to like parts, components, and structures.

### DETAILED DESCRIPTION

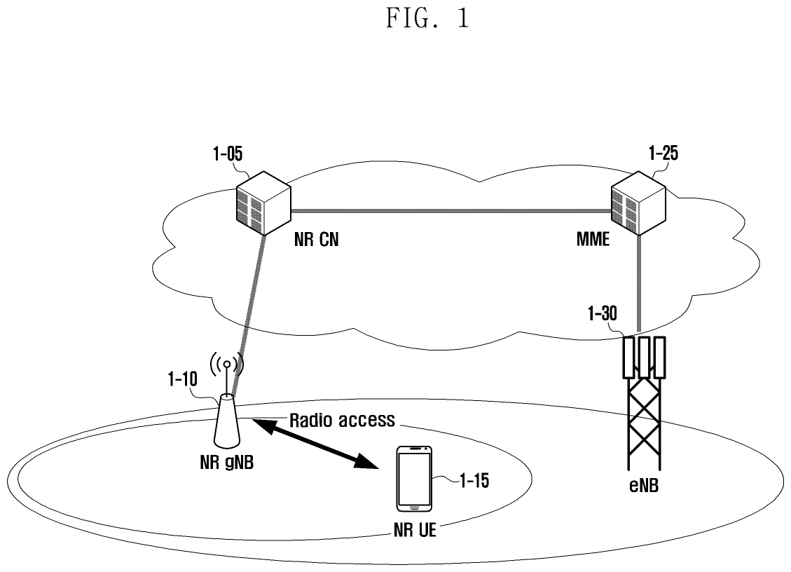

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit,” “module” or the like may refer to a software component or hardware component, such as, for example, a field-programmable gate array (FPGA) or an application-specific integrated circuit (ASIC) capable of carrying out a function or an operation. However, a “unit,” or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

FIG. 1 illustrates a structure of a next-generation mobile communication system according to various embodiments of the present disclosure.

Referring to FIG. 1, the radio access network of the next-generation mobile communication system includes a next-generation base station 1-10 (hereinafter, interchangeably used with new radio node B, NR NB, next generation nodeB, gNodeB, or gNB) and a new radio core network (NR CN) 1-05 (or next generation core network (NG CN). Auser terminal 1-15 (new radio user equipment) (hereinafter, referred to as a NR UE or a UE) accesses an external network through the NR NB 1-10 and the NR CN 1-05.

In FIG. 1, the NR NB 1-10 corresponds to an evolved Node B (eNB) of the conventional LTE system. The NR NB may be connected to an NR UE 1-15 through a radio channel and may provide better service than the conventional node B. Since all user traffic is served through a shared channel in the next-generation mobile communication system, a device for collecting and scheduling status information of buffer statuses, available transmission power statuses, and channel statuses of UEs is required, and corresponds to the NR NB 1-10. One NR NB generally controls a plurality of cells. The NR NB may have a bandwidth wider than the conventional maximum bandwidth in order to implement super-high-speed data transmission compared to conventional LTE, may apply orthogonal frequency-division multiplexing (OFDM) through radio access technology, and may further apply beamforming technology. Further, an adaptive modulation and coding (AMC) scheme of determining a modulation scheme and a channel-coding rate is applied depending on the channel status of the UE. The NR CN 1-05 performs a function of supporting mobility, configuring a bearer, and configuring a quality of service (QoS). The NR CN is a device which performs not only a function of managing mobility of the UE but also various control functions and is connected to a plurality of eNBs. Further, the next-generation mobile communication system may be linked to the conventional LTE system, and the NR CN is connected to an MME 1-25 through a network interface. The MME is connected to an eNB 1-30, which is a conventional base station.

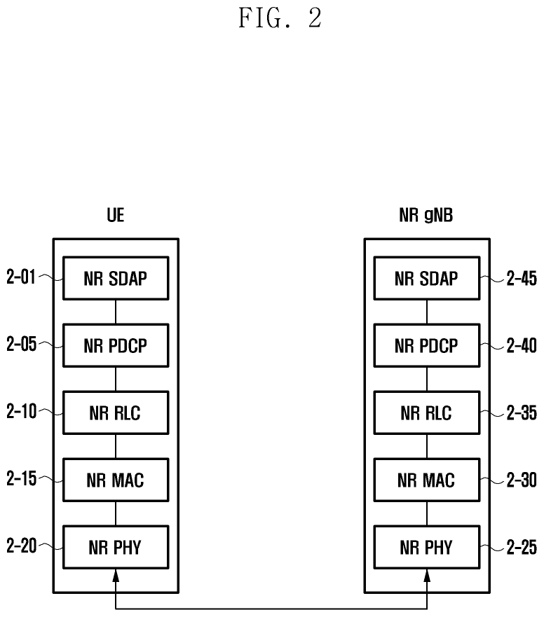

FIG. 2 illustrates a wireless protocol structure of the next-generation mobile communication system according to various embodiments of the present disclosure.

Referring to FIG. 2, the wireless protocol of the next-generation mobile communication system includes NR service data adaptation protocols (SDAPs) 2-01 and 2-45, NR PDCPs 2-05 and 2-40, NR RLCs 2-10 and 2-35, and NR MACs 2-15 and 2-30 in the UE and the NR gNB.

The main functions of the NR SDAPs 2-01 and 2-45 may include some of the following functions:
User data transmission function (transfer of user-plane data);
Function of mapping QoS flow and a data bearer for uplink and downlink (mapping between a QoS flow and a DRB for both DL and UL);
Function of marking a QoS flow identifier (ID) for uplink and downlink (marking QoS flow ID in both DL and UL packets); and
Function of mapping reflective QoS flow to a data bearer for uplink SDAP PDUs (reflective QoS flow to DRB mapping for the UL SDAP PDUs).

With respect to the SDAP layer device, the UE may receive a configuration as to whether to use a header of the SDAP layer device or a function of the SDAP layer device for each PDCP layer device, each bearer, or each logical channel through an RRC message. If the SDAP header is configured, a 1-bit indicator of NAS reflective QoS of the SDAP header and a 1 bit-indicator of AS reflective QoS may indicate that the UE updates or reconfigures information on mapping of QoS flow and a data bearer in uplink and downlink. The SDAP header may include QoS flow ID information indicating the QoS. The QoS information may be used as data-processing-priority or scheduling information to support a seamless service.

The main functions of the NR PDCP 2-05 or 2-40 may include some of the following functions:
Header compression and decompression function (header compression and decompression: ROHC only);
User data transmission function (transfer of user data);
Sequential delivery function (in-sequence delivery of upper layer PDUs);
Non-sequential delivery function (out-of-sequence delivery of upper-layer PDUs);
Reordering function (PDCP PDU reordering for reception);
Duplicate detection function (duplicate detection of lower-layer SDUs);
Retransmission function (retransmission of PDCP SDUs);
Ciphering and deciphering function (ciphering and deciphering); and
Timer-based SDU removal function (timer-based SDU discard in uplink).

The reordering function of the NR PDCP device is a function of sequentially reordering PDCP PDUs received by a lower layer on the basis of a PDCP sequence number (SN), and may include a function of sequentially transferring the reordered data to a higher layer, a function of directly transmitting the reordered data without regard to the order, a function of recording PDCP PDUs lost due to the reordering, a function of reporting statuses of the lost PDCP PDUs to a transmitting side, and a function of making a request for retransmitting the lost PDCP PDUs.

The main functions of the NR RLC 2-10 or 2-35 may include some of the following functions:
Data transmission function (transfer of upper-layer PDUs);
Sequential delivery function (in-sequence delivery of upper layer PDUs);
Non-sequential delivery function (out-of-sequence delivery of upper-layer PDUs);
ARQ function (error correction through ARQ);
Concatenation, segmentation, and reassembly function (concatenation, segmentation, and reassembly of RLC SDUs);
Re-segmentation function (re-segmentation of RLC data PDUs);
Reordering function (reordering of RLC data PDUs);
Duplicate detection function (duplicate detection);
Error detection function (protocol error detection);
RLC SDU deletion function (RLC SDU discard); and
RLC reestablishment function (RLC reestablishment).

The sequential delivery function (In-sequence delivery) of the NR RLC device is a function of sequentially transferring RLC PDUs received from a lower layer to a higher layer, and may include, when one original RLC SDU is divided into a plurality of RLC SDUs and then received, a function of reassembling and transmitting the RLC SDUs, a function of reordering the received RLC PDUs on the basis of an RLC sequence number (SN) or a PDCP SN, a function of recording RLC PDUs lost due to the reordering, a function of reporting statuses of the lost RLC PDUs to a transmitting side, a function of making a request for retransmitting the lost RLC PDUs, if there is a lost RLC SDU, a function of sequentially transferring only RLC SDUs preceding the lost RLC SDU to the higher layer if a predetermined timer expires when there is a lost RLC SDU, a function of sequentially transferring all RLC SDUs received before the timer starts to the higher layer, or if a predetermined timer expires when there is a lost RLC SDU, and a function of sequentially transferring all RLC SDUs received up to that point in time to the higher layer.

Further, the NR RLC device may process the RLC PDUs sequentially in the order of reception thereof (according to an arrival order regardless of a serial number or a sequence number) and may transfer the RLC PDUs to the PDCP device regardless of the sequence thereof (out-of-sequence delivery). In the case of segments, the NR RLC device may receive segments that are stored in the buffer or are to be received in the future, reconfigure the segments to be one RLC PDU, process the RLC PDU, and then transmit the same to the PDCP device. The NR RLC layer may not include a concatenation function, and the function may be performed by the NR MAC layer, or may be replaced with a multiplexing function of the NR MAC layer.

The non-sequential delivery function (out-of-sequence delivery) of the NR RLC device is a function of transferring RLC SDUs received from a lower layer directly to a higher layer regardless of the sequence of the RLC SDUs, and may include, when one original RLC SDU is divided into a plurality of RLC SDUs and then received, a function of reassembling and transmitting the RLC PDUs and a function of storing RLC SNs or PDCP SNs of the received RLC PDUs, reordering the RLC PDUs, and recording lost RLC PDUs.

The NR MACs 2-15 and 2-30 may be connected to a plurality of NR RLC layer devices configured in one UE, and the main functions of the NR MACs may include some of the following functions:
Mapping function (mapping between logical channels and transport channels);
Multiplexing and demultiplexing function (multiplexing/demultiplexing of MAC SDUs);
Scheduling information report function (scheduling information reporting);
HARQ function (error correction through HARQ);
Logical channel priority control function (priority handling between logical channels of one UE);
UE priority control function (priority handling between UEs by means of dynamic scheduling);
MBMS service identification function (MBMS service identification);
Transport format selection function (transport format selection); and
Padding function (padding).

The NR PHY layers 2-20 and 2-25 perform an operation for channel-coding and modulating higher-layer data to generate an OFDM symbol and transmitting the OFDM symbol through a radio channel or demodulating and channel-decoding the OFDM symbol received through the radio channel and transmitting the demodulated and channel-decoded OFDM symbol to the higher layer.

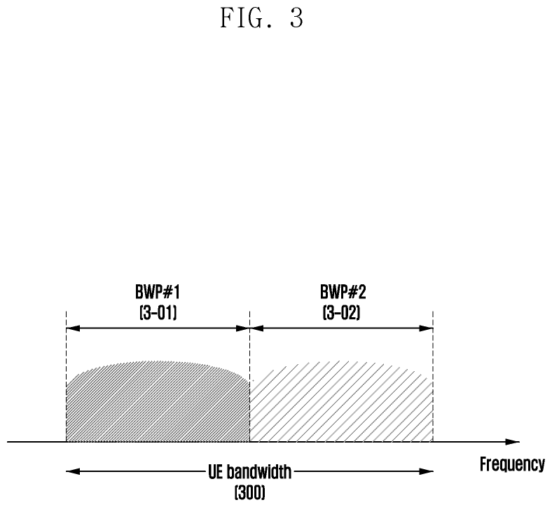

FIG. 3 illustrates an example of configuration a bandwidth part in a wireless communication system according to various embodiments of the present disclosure.

Referring to FIG. 3, an example, in which a UE bandwidth 300 is configured by two BWPs, that is, BWP #1 301 and BWP #2 302, is shown. The base station may configure one or multiple BWPs for the UE, and may configure pieces of information as shown in Table 1 below for each bandwidth part.

TABLE 1

| | |
|---|---|
| BWP ::= | SEQUENCE { |
| bwp-Id | BWP-Id, |

(Bandwidth part identifier)

| | |
|---|---|
| locationAndBandwidth | INTEGER (1..65536), |

(Bandwidth part location)

| | |
|---|---|
| subcarrierSpacing | ENUMERATED {n0, n1, n2, n3, n4, n5}, |

(Subcarrier spacing)

| | |
|---|---|
| cyclicPrefix | ENUMERATED { extended } |

(Cyclic prefix)
}

An embodiment of the disclosure is not limited to the above example, and in addition to the configuration information, various parameters related to a BWP may be configured in the UE and some pieces of information may be omitted. The pieces of information may be transmitted by the base station to the UE via higher layer signaling, for example, radio resource control (RRC) signaling. At least one BWP among the configured one or multiple BWPs may be activated. Whether to activate the configured BWP may be semi-statically transmitted from the base station to the UE via RRC signaling or may be dynamically transmitted through downlink control information (DCI).

According to some embodiments, a UE before radio resource control (RRC) connection may be configured with an initial bandwidth part (BWP) for initial access from a base station through a master information block (MIB). More specifically, the UE may receive configuration information about a search apace and a control resource set (CORESET) through which the PDCCH for reception of system information required for initial access (which may correspond to remaining system information (RMSI) or system information block 1 (SIB 1)) may be transmitted through the MIB in an initial access operation. The control resource set (CORESET) and search space, which are configured through the MIB, may be regarded as identity (ID) 0, respectively. The base station may notify the UE of configuration information, such as frequency allocation information, time allocation information, and numerology for the control resource set #0 through the MIB. In addition, the base station may notify the UE of configuration information regarding the monitoring periodicity and occasion for the control resource set #0, that is, configuration information regarding the search space #0, through the MIB. The UE may regard the frequency domain configured as the control resource set #0, obtained from the MIB, as an initial BWP for initial access. Here, the identifier (ID) of the initial BWP may be regarded as zero.

The configuration of the BWP supported by 5G may be used for various purposes.

According to some embodiments, a case, in which a bandwidth supported by the UE is less than a system bandwidth, may be supported through the BWP configuration. For example, the base station configures, in the UE, a frequency location (configuration information 2) of the BWP to enable the UE to transmit or receive data at a specific frequency location within the system bandwidth.

Further, according to some embodiments, the base station may configure multiple BWPs in the UE for the purpose of supporting different numerologies. For example, in order to support both data transmission/reception to/from a predetermined UE by using a subcarrier spacing of 15 kHz and a subcarrier spacing of 30 kHz, two BWPs may be configured to use a subcarrier spacing of 15 kHz and a subcarrier spacing of 30 kHz, respectively. Different BWPs may be frequency division multiplexed, and when attempting to transmit or receive data at a specific subcarrier spacing, the BWP configured with the corresponding subcarrier spacing may be activated.

In addition, according to some embodiments, the base station may configure, in the UE, the BWPs having bandwidths of different sizes for the purpose of reducing power consumption of the UE. For example, when the UE supports a very large bandwidth, for example, a bandwidth of 100 MHz, and always transmits or receives data at the corresponding bandwidth, the transmission or reception may cause very high power consumption in the UE. In particular, when the UE performs monitoring on an unnecessary downlink control channel of a large bandwidth of 100 MHz even when there is no traffic, the monitoring may be very inefficient in terms of power consumption. Therefore, in order to reduce power consumption of the UE, the base station may configure, for the UE, a BWP of a relatively small bandwidth, for example, a BWP of 20 MHz. In a situation without traffic, the UE may perform a monitoring operation on a BWP of 20 MHz. When data to be transmitted or received has occurred, the UE may transmit or receive data in a BWP of 100 MHz according to an indication of the base station.

In a method of configuring the BWP, the UEs before the RRC connection may receive configuration information about the initial bandwidth part through the master information block (MIB) in the initial connection operation. More specifically, the UE may be configured with a control resource set (CORESET) for a downlink control channel through which downlink control information (DCI) for scheduling a system information block (SIB) may be transmitted from a MIB of a physical broadcast channel (PBCH). The bandwidth of the control resource set configured through the MIB may be regarded as the initial BWP. The UE may receive, through the configured initial BWP, a physical downlink shared channel (PDSCH) through which the SIB is transmitted. The initial BWP may be used for other system information (OSI), paging, and random access as well as the reception of the SIB.

In the recent years, several broadband wireless technologies have been developed to meet the growing number of broadband subscribers and to provide more and better applications and services. The second generation wireless communication system has been developed to provide voice services while ensuring the mobility of users. The third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So, the fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive MIMO, FD-MIMO, array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system may be flexible enough to serve the UEs having quite different capabilities depending on the use case and market segment the UE cater service to the end customer.

Few example use cases the fifth generation wireless communication system wireless system is expected to address is eMBB, m-MTC, URLL etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the IoT/IoE envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, a UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance.

Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as TX beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of RX beam patterns of different directions. Each of these receive patterns can be also referred as an RX beam.

CA/Multi-connectivity in fifth generation wireless communication system: The fifth generation wireless communication system, supports standalone mode of operation as well dual connectivity (DC). In DC, a multiple Rx/Tx UE may be configured to utilize resources provided by two different nodes (or NBs) connected via non-ideal backhaul. One node acts as the master node (MN) and the other as the secondary node (SN). The MN and SN are connected via a network interface and at least the MN is connected to the core network. NR also supports multi-RAT dual connectivity (MR-DC) operation whereby a UE in RRC_CONNECTED is configured to utilize radio resources provided by two distinct schedulers, located in two different nodes connected via a non-ideal backhaul and providing either E-UTRA (i.e., if the node is an ng-eNB) or NR access (i.e., if the node is a gNB).

In NR for a UE in RRC_CONNECTED not configured with CA/DC there is only one serving cell comprising of the primary cell. For a UE in RRC_CONNECTED configured with CA/DC the term “serving cells” is used to denote the set of cells comprising of the special cell(s) and all secondary cells. In NR, the term master cell group (MCG) refers to a group of serving cells associated with the master node, comprising of the PCell and optionally one or more SCells. In NR, the term secondary cell group (SCG) refers to a group of serving cells associated with the Secondary Node, comprising of the PSCell and optionally one or more SCells. In NR PCell (primary cell) refers to a serving cell in MCG, operating on the primary frequency, in which the UE either performs the initial connection establishment procedure or initiates the connection re-establishment procedure.

In NR for a UE configured with CA, Scell is a cell providing additional radio resources on top of special cell. Primary SCG Cell (PSCell) refers to a serving cell in SCG in which the UE performs random access when performing the reconfiguration with sync procedure. For dual connectivity operation the term SpCell (i.e., Special Cell) refers to the PCell of the MCG or the PSCell of the SCG, otherwise the term special cell refers to the PCell.

UE states in fifth generation wireless communication system: In the 5G wireless communication system, an RRC can be in one of the following states: RRC_IDLE, RRC_INACTIVE, and RRC_CONNECTED. A UE is either in an RRC_CONNECTED state or in an RRC_INACTIVE state when an RRC connection has been established. If this is not the case, i.e., no RRC connection is established, the UE is in the RRC_IDLE state. The RRC states can further be characterized as follows:

In the RRC_IDLE, a UE specific DRX may be configured by upper layers. The UE monitors short messages transmitted with P-RNTI over DCI; monitors a paging channel for CN paging using 5G-S-TMSI; performs neighboring cell measurements and cell (re-)selection; acquires system information and can send SI request (if configured); performs logging of available measurements together with location and time for logged measurement configured UEs.

In an RRC_INACTIVE, a UE specific DRX may be configured by upper layers or by an RRC layer; the UE stores the UE inactive AS context; a RAN-based notification area is configured by RRC layer. The UE monitors short messages transmitted with P-RNTI over DCI; monitors a paging channel for CN paging using 5G-S-TMSI and RAN paging using full I-RNTI; performs neighboring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from UE takes place. The UE monitors short messages transmitted with P-RNTI over DCI, if configured; monitors control channels associated with the shared data channel to determine if data is scheduled for the UE; provides channel quality and feedback information; performs neighbouring cell measurements and measurement reporting; acquires system information.

Downlink control in the 5G wireless communication system: In the 4G wireless communication system, physical downlink control channel (PDCCH) is used to schedule DL transmissions on PDSCH and UL transmissions on PUSCH, where the downlink control information (DCI) on PDCCH includes: downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH.

In addition to scheduling, PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; Transmission of one or more TPC commands for SRS transmissions by one or more UEs; switching a UE's active bandwidth part; Initiating a random access procedure. A UE monitors a set of PDCCH candidates in the configured monitoring occasions in one or more configured control resource sets (CORESETs) according to the corresponding search space configurations. A CORESET includes a set of PRBs with a time duration of 1 to 3 OFDM symbols. The resource units resource element groups (REGs) and control channel elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the 5G wireless communication system, a list of search space configurations are signaled by a GNB for each configured BWP wherein each search configuration is uniquely identified by an identifier. Identifier of search space configuration to be used for specific purpose such as paging reception, SI reception, random access response reception is explicitly signaled by a gNB. In NR search space configuration comprises of parameters monitoring-periodicity-PDCCH-slot, monitoring-offset-PDCCH-slot, monitoring-symbols-PDCCH-within-slot and duration. A UE determines PDCCH monitoring occasion (s) within a slot using the parameters PDCCH monitoring periodicity (monitoring-periodicity-PDCCH-slot), the PDCCH monitoring offset (monitoring-offset-PDCCH-slot), and the PDCCH monitoring pattern (Monitoring-symbols-PDCCH-within-slot). PDCCH monitoring occasions are there in slots “x” to x+duration where the slot with number “x” in a radio frame with number “y” satisfies the equation as given by:

(y*(number of slots in a radio frame)+x−Monitoring-offset-PDCCH-slot)mod (Monitoring-periodicity-PDCCH-slot)=0.

The starting symbol of a PDCCH monitoring occasion in each slot having PDCCH monitoring occasion is given by monitoring-symbols-PDCCH-within-slot. The length (in symbols) of a PDCCH monitoring occasion is given in the corset associated with the search space. The search space configuration includes the identifier of coreset configuration associated with the search space. A list of coreset configurations are signaled by gNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depend on a radio frame for each supported SCS is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by a gNB via RRC signaling. One of the TCI state in TCI state list is activated and indicated to UE by a gNB. TCI state indicates the DL TX beam (DL TX beam is QCLed with SSB/CSI RS of TCI state) used by GNB for transmission of PDCCH in the PDCCH monitoring occasions of a search space.

Bandwidth part in the 5G wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility), and the subcarrier spacing can be ordered to change (e.g., to allow different services). A subset of the total cell bandwidth of a cell is referred to as a BWP. BA is achieved by configuring RRC connected UE with BWP(s) and telling the UE which of the configured BWPs is currently the active one. When BA is configured, the UE only has to monitor PDCCH on the one active BWP i.e., the UE may not have to monitor PDCCH on the entire DL frequency of the serving cell. In an RRC connected state, UE is configured with one or more DL and UL BWPs, for each configured serving cell (i.e., PCell or SCell).

For an activated serving cell, there is always one active UL and DL BWP at any point in time. The BWP switching for a serving cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of random access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a serving cell is indicated by either RRC or PDCCH. For unpaired spectrum, a DL BWP is paired with a UL BWP, and BWP switching is common for both UL and DL. Upon expiry of BWP inactivity timer, a UE switches to the active DL BWP to the default DL BWP or initial DL BWP (if default DL BWP is not configured).

In an RRC_IDLE and an RRC_INACTIVE state, a UE receives downlink transmission from gNB in initial DL BWP and the UE transmits uplink transmissions in initial UL BWP. Initial DL BWP configuration is signaled by the field initialDownlinkBWP in system information (SIB1). Initial UL BWP configuration is signaled by the field initialUplinkBWP in system information (SIB1).

Random access in the 5G wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random access procedure is supported.

Contention based random access (CBRA): This is also referred as 4 step CBRA. In this type of random access, a UE first transmits random access preamble (also referred as Msg1) and then waits for random access response (RAR) in the RAR window. RAR is also referred as Msg2. Next generation node B (gNB) transmits the RAR on physical downlink shared channel (PDSCH). PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by a gNB.

The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various random access preambles detected by a gNB can be multiplexed in the same RAR media access control (MAC) protocol data unit (PDU) by a gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by a gNB in RACH configuration) number of times, the UE goes back to first step i.e., select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. The Msg3 may include the UE identity (i.e., cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives a physical downlink control channel (PDCCH) addressed to C-RNTI included in Msg3, contention resolution is considered successful, contention resolution timer is stopped and RA procedure is completed. While the contention resolution timer is running, if UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step i.e., select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for secondary cell (Scell), etc. Evolved node B (eNB) assigns to a UE dedicated random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to contention based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by a gNB in RACH configuration) number of times, the UE retransmits the RA preamble.

For certain events such has handover and beam failure recovery if dedicated preamble(s) are assigned to a UE, during first step of random access i.e., during random access resource selection for Msg1 transmission, a UE determines whether to transmit dedicated preamble or non dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e., dedicated preambles/Ros) are provided by a gNB, UE select non dedicated preamble. Otherwise, UE select dedicated preamble. So, during the RA procedure, one random access attempt can be CFRA while other random access attempt can be CBRA.

2 step contention based random access (2 step CBRA). In the first step, a UE transmits random access preamble on PRACH and a payload (i.e., MAC PDU) on PUSCH. The random access preamble and payload transmission is also referred as MsgA. In the second step, after MsgA transmission, the UE monitors for a response from the network (i.e., gNB) within a configured window. The response is also referred as MsgB. Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by a gNB. The MSGB-RNTI is calculated as follows. RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If CCCH SDU was transmitted in MsgA payload, a UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, the UE transmits Msg3 and performs contention resolution using Msg4 as in CBRA procedure. If contention resolution is successful, random access procedure is considered successfully completed. If contention resolution fails upon fallback (i.e., upon transmitting Msg3), the UE retransmits MsgA. If configured window in which the UE monitors network response after transmitting MsgA expires and the UE has not received MsgB including contention resolution information or fallback information as explained above, the UE retransmits MsgA. If the random access procedure is not successfully completed even after transmitting the msgA configurable number of times, the UE fallbacks to 4 step RACH procedure i.e., the UE only transmits the PRACH preamble.

MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. MsgA may include a UE ID (e.g., random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure.

When a UE performs RA after power on (before the UE is attached to the network), then UE ID is the random ID. When the UE performs RA in IDLE state after the UE is attached to network, the UE ID is S-TMSI. If the UE has an assigned C-RNTI (e.g., in connected state), the UE ID is C-RNTI. In case the UE is in INACTIVE state, the UE ID is resume ID. In addition to the UE ID, some addition control information can be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case, a gNB assigns to a UE dedicated random access preamble (s) and PUSCH resource(s) for MsgA transmission. RO(s) to be used for preamble transmission may also be indicated. In the first step, UE transmits random access preamble on PRACH and a payload on PUSCH using the contention free random access resources (i.e., dedicated preamble/PUSCH resource/RO). In the second step, after MsgA transmission, the UE monitors for a response from the network (i.e., gNB) within a configured window. The response is also referred as MsgB.

A next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by a gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If a UE receives PDCCH addressed to C-RNTI, a random access procedure is considered successfully completed. If the UE receives fallback information corresponding to its transmitted preamble, the random access procedure is considered successfully completed.

For certain events such has handover and beam failure recovery if dedicated preamble(s) and PUSCH resource(s) are assigned to a UE, during first step of random access i.e., during random access resource selection for MsgA transmission, the UE determines whether to transmit dedicated preamble or non-dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e., dedicated preambles/Ros/PUSCH resources) are provided by a gNB, the UE selects non dedicated preamble. Otherwise, the UE selects dedicated preamble. So, during the RA procedure, one random access attempt can be 2 step CFRA while other random access attempt can be 2 step CBRA.

Upon initiation of random access procedure, a UE first selects the carrier (SUL or NUL). If the carrier to use for the random access procedure is explicitly signaled by a gNB, the UE selects the signalled carrier for performing a random access procedure. If the carrier to use for the random access procedure is not explicitly signaled by the gNB; and if the serving cell for the random access procedure is configured with supplementary uplink and if the RSRP of the downlink pathloss reference is less than rsrp-ThresholdSSB-SUL: the UE selects the SUL carrier for performing random access procedure. Otherwise, the UE selects the NUL carrier for performing random access procedure. Upon selecting the UL carrier, the UE determines the UL and DL BWP for random access procedure as specified in section 5.15 of TS 38.321. The UE then determines whether to perform 2 step or 4 step RACH for this random access procedure as shown below.
If this random access procedure is initiated by PDCCH order and if the ra-PreambleIndex explicitly provided by PDCCH is not 0b000000, UE selects 4 step RACH.
else if 2 step contention free random access resources are signaled by a gNB for this random access procedure, UE selects 2 step RACH.
else if 4 step contention free random access resources are signaled by a gNB for this random access procedure, UE selects 4 step RACH.
else if the UL BWP selected for this random access procedure is configured with only 2 step RACH resources, UE selects 2 step RACH.
else if the UL BWP selected for this random access procedure is configured with only 4 step RACH resources, UE selects 4 step RACH.
else if the UL BWP selected for this random access procedure is configured with both 2 step and 4 step RACH resources.
if RSRP of the downlink pathloss reference is below a configured threshold, UE selects 4 step RACH. Otherwise, the UE selects 2 step RACH.

Upon initiation of the random access procedure on a serving cell, after the selection of carrier for performing random access procedure, the MAC entity may for the selected carrier of this serving cell:

*1> if PRACH occasions are not configured for the active UL BWP:

**2> switch the active UL BWP to BWP indicated by initialUplinkBWP;

**2> if the serving cell is an SpCell:

***3> switch the active DL BWP to BWP indicated by initialDownlinkBWP.

*1> else:

**2> if the serving cell is an SpCell:

***3> if the active DL BWP may not have the same bwp-Id as the active UL BWP:

****4> switch the active DL BWP to the DL BWP with the same bwp-Id as the active UL BWP.

*1> if the defaultDownlinkBWP-Id is configured, and the active DL BWP is not the BWP indicated by the defaultDownlinkBWP-Id, and the active DL BWP is not the BWP indicated by the dormantBWP-Id if configured; or

*1> if the defaultDownlinkBWP-Id is not configured, and the active DL BWP is not the initialDownlinkBWP, and the active DL BWP is not the BWP indicated by the dormantBWP-Id if configured:

**2> if the bwp-InactivityTimer associated with the active DL BWP expires:

***3> if the defaultDownlinkBWP-Id is configured:

****4> perform BWP switching to a BWP indicated by the defaultDownlinkBWP-Id.

***3> else:

****4> perform BWP switching to the initialDownlinkBWP.

In the current design, one initial Uplink BWP and one initial downlink BWP is configured in a cell. There is one initial UL BWP on an Uplink carrier of serving cell. There is one initial downlink BWP on downlink carrier of serving cell. In order to support reduced capability UEs, additional initial uplink BWP can be configured on uplink carrier of serving cell and an additional downlink BWP can be configured on downlink carrier of serving cell. The issue is how to handle BWP operation when two initial Uplink BWP and two initial downlink BWP are configured in a cell. To which of the two initial uplink BWP the UE may switch when RACH occasions are not configured in active UL BWP or when bwp-InactivityTimer expires.

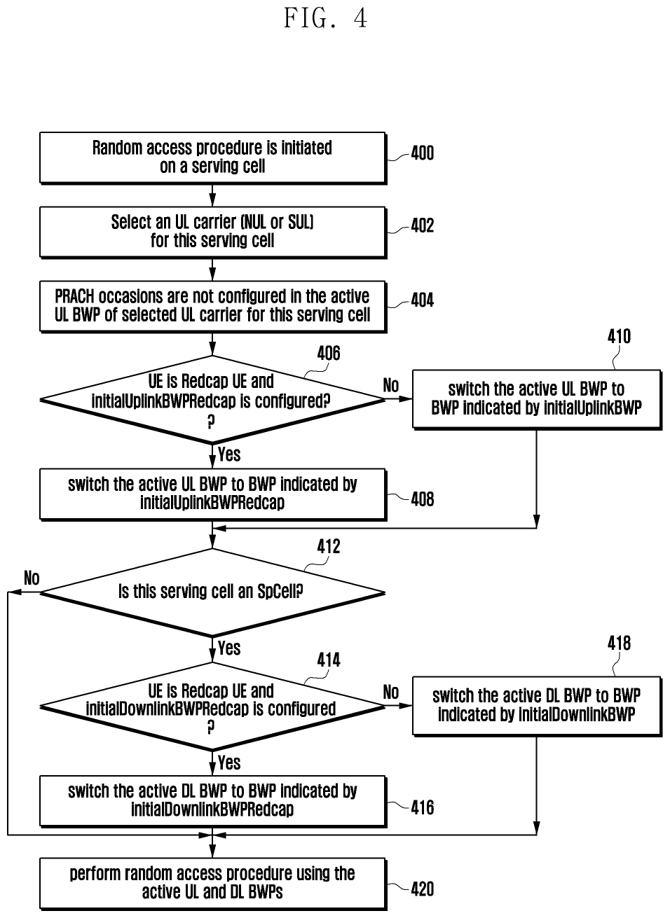

FIG. 4 illustrates an example of BWP switching when a random access procedure is initiated according to various embodiments of the present disclosure.

In one example of the present disclosure, a UE can be configured with a first and/or second initial UL BWP on NUL carrier. A UE can be configured with a first and/or second initial UL BWP on SUL carrier. A UE can be configured with a first and/or second initial DL BWP. First initial UL BWP on a carrier and first initial DL BWP is for non-RedCap UEs. second initial UL on a carrier and second initial DL BWP is for RedCap UEs. A reduced capability (RedCap) UE is the UE which supports reduced number of UE RX/TX antennas, reduced bandwidth, relaxed UE processing time, relaxed UE processing capability, reduced maximum number of DL MIMO layers, relaxed maximum modulation order, relaxed duplex operation, etc. The first initial UL BWP can be indicated by a field initialUplinkBWP in an RRCReconfiguration message or system information. The second initial UL BWP can be indicated by a field initialUplinkBWPRedcap in an RRCReconfiguration message or system information. The second initial UL BWP can also be indicated by another name. The first initial DL BWP can be indicated by field initialDownlinkBWP in RRCReconfiguration message or system information. The second initial DL BWP can be indicated by a field initialDownlinkBWPRedcap in an RRCReconfiguration message or system information.

Upon initiation of the random access procedure on a serving cell, after the selection of carrier for performing random access procedure, the MAC entity UE may for the selected carrier of this serving cell perform the following operation:

*1> if PRACH occasions are not configured for the active UL BWP:

**2> if a UE is RedCap and if initialUplinkBWPRedcap (i.e., second initial UL BWP) is configured:

***3> switch the active UL BWP to BWP indicated by initialUplinkBWPRedcap (i.e., switch the active UL BWP to second initial UL BWP);

**2> else (i.e., a UE is not redcap OR a UE is RedCap but initialUplinkBWPRedcap is not configured):

***3> switch the active UL BWP to BWP indicated by initialUplinkBWP (i.e., switch the active UL BWP to first initial UL BWP);

**2> if the serving cell is an SpCell:

***3> if a UE is RedCap and if initialDownlinkBWPRedcap (i.e., second initial DL BWP) is configured:

****4> switch the active DL BWP to BWP indicated by initialDownlinkBWPRedcap (i.e., switch the active DL BWP to second initial DL BWP);

***3> else (i.e., a UE is not a redcap OR a UE is redcap but initialDownlinkBWPRedcap is not configured):

****4> switch the active DL BWP to BWP indicated by initialDownlinkBWP (i.e., switch the active DL BWP to first initial UL BWP).

Referring to FIG. 4, in operation 400, a UE may identify that a random access procedure is initiated on a serving cell. In operation 402, the UE may select an UL carrier for this serving cell. The selected UL carrier may an NUL or an SUL. In operation 404, the UE may identify that PRACH occasions are not configured in an active UL BWP of the selected UL carrier for this serving cell. In operation 406, the UE may identify whether the UE is a redcap UE and/or whether an initial uplink BWP for redcap UE (e.g., initialUplinkBWPRedcap) is configured.

Alternatively, the UE is a redcap UE and the UE may identify whether initialUplinkBWPRedcap is configured, in operation 406. If the UE is a redcap UE and initialUplinkBWPRedcap is configured, the UE may switch the active UL BWP to a BWP indicated by initialUplinkBWPRedcap, in operation 408. If the UE is not a redcap UE or if the UE is a redcap UE but initialUplinkBWPRedcap is not configured, the UE may switch the active UL BWP to a BWP indicated by initialUplinkBWP, in operation 410. In operation 412, the UE may identify whether this serving cell is an SpCell. If this serving cell is an SpCell, the UE may identify whether the UE is a redcap UE and/or whether an initial downlink BWP for redcap UE (e.g., initialDownlinkBWPRedcap) is configured in operation 414.

Alternatively, the UE is a redcap UE and the UE may identify whether initialDownlinkBWPRedcap is configured in operation 414. If the UE is a redcap UE and initialDownlinkBWPRedcap is configured, the UE may switch the active DL BWP to a BWP indicated by initialDownlinkBWPRedcap, in operation 416. If the UE is not a redcap UE or if the UE is a redcap UE but initialDownlinkBWPRedcap is not configured, the UE may switch the active DL BWP to a BWP indicated by initialDownlinkBWP, in operation 418. In operation 420, the UE may perform the random access procedure using the active UL and DL BWPs. If this serving cell is not an SpCell (i.e., if this serving cell is an SCell), the UE may perform the random access procedure in operation 420 using the active UL and DL BWPs without switching of DL BWP.

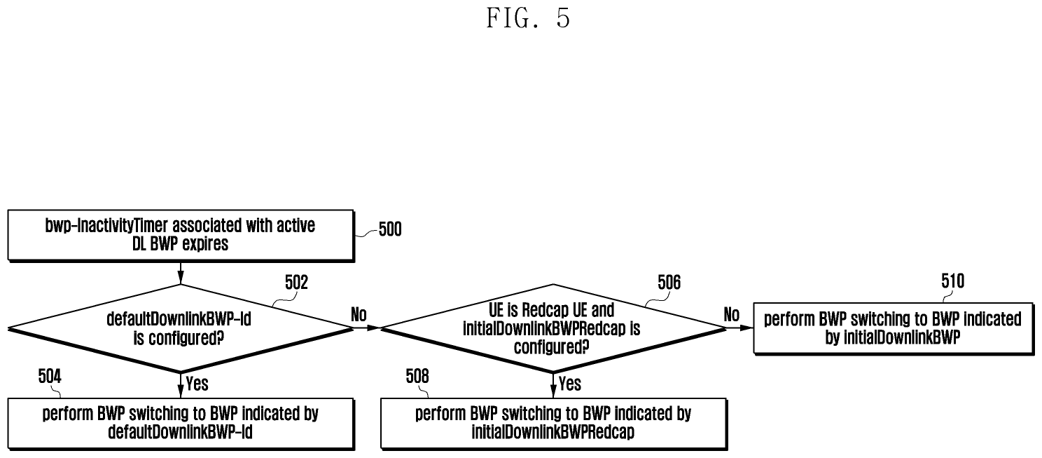

FIG. 5 illustrates an example of BWP switching when a BWP inactivity timer expires according to various embodiments of the present disclosure.

In one example of the present disclosure, a UE can be configured with a first and/or second initial UL BWP on NUL carrier. A UE can be configured with a first and/or second initial UL BWP on SUL carrier. A UE can be configured with a first and/or second initial DL BWP. The first initial UL BWP on a carrier and the first initial DL BWP is for non-RedCap UEs. The second initial UL on a carrier and the second initial DL BWP is for RedCap UEs. A RedCap UE is the UE which supports reduced number of UE RX/TX antennas, reduced bandwidth, relaxed UE processing time, relaxed UE processing capability, reduced maximum number of DL MIMO layers, relaxed maximum modulation order, relaxed duplex operation, etc. The first initial UL BWP can be indicated by a field initialUplinkBWP in an RRCReconfiguration message or system information. The second initial UL BWP can be indicated by a field initialUplinkBWPRedcap in an RRCReconfiguration message or system information. The second initial UL BWP can also be indicated by another name. The first initial DL BWP can be indicated by field initial DownlinkBWP in RRCReconfiguration message or system information. The second initial DL BWP can be indicated by a field initialDownlinkBWPRedcap in an RRCReconfiguration message or system information.

A UE operation for each activated serving cell configured with bwp-InactivityTimer is as follows:

*1> if the defaultDownlinkBWP-Id is configured, and the active DL BWP is not the BWP indicated by the defaultDownlinkBWP-Id, and the active DL BWP is not the BWP indicated by the dormantBWP-Id if configured; or

*1> if a UE is not the redcap UE and if the defaultDownlinkBWP-Id is not configured, and the active DL BWP is not the initialDownlinkBWP (i.e., first initial DL BWP), and the active DL BWP is not the BWP indicated by the dormantBWP-Id if configured; or

*1> if a UE is RedCap and if the defaultDownlinkBWP-Id is not configured, and if the initialDownlinkBWPRedcap (i.e. second initial DL BWP) is configured and the active DL BWP is not the initialDownlinkBWPRedcap (i.e. second initial DL BWP), and the active DL BWP is not the BWP indicated by the dormantBWP-Id if configured (Note that the UE checks if active DL BWP is not the BWP indicated by the dormantBWP-Id only for the case dormantBWP-Id is configured for the serving cell; in case donnantBWP-Id is not configured for the redcap UE, the redcap UE may not perform this check); or

*1> if a UE is RedCap and if the defaultDownlinkBWP-Id is not configured, and if the initialDownlinkBWPRedcap (i.e. second initial DL BWP) is not configured and the active DL BWP is not the initialDownlinkBWP (i.e. first initial DL BWP), and the active DL BWP is not the BWP indicated by the dormantBWP-Id if configured (Note that the UE checks if active DL BWP is not the BWP indicated by the dormantBWP-Id only for the case dormantBWP-Id is configured for the serving cell; in case dormantBWP-Id is not configured for the redcap UE, the redcap UE may not perform this check):

**2> if a PDCCH addressed to C-RNTI or CS-RNTI indicating downlink assignment or uplink grant is received on the active BWP; or

**2> if a PDCCH addressed to C-RNTI or CS-RNTI indicating downlink assignment or uplink grant is received for the active BWP; or

**2> if a MAC PDU is transmitted in a configured uplink grant and LBT failure indication is not received from lower layers; or

**2> if a MAC PDU is received in a configured downlink assignment:

***3> if there is no ongoing random access procedure associated with this serving cell; or

***3> if the ongoing random access procedure associated with this serving cell is successfully completed upon reception of this PDCCH addressed to C-RNTI:

****4> start or restart the bwp-InactivityTimer associated with the active DL BWP:

**2> if the bwp-InactivityTimer associated with the active DL BWP expires:

***3> if the defaultDownlinkBWP-Id is configured:

****4> perform BWP switching to a BWP indicated by the defaultDownlinkBWP-Id.

***3> else:

****4> if a UE is a RedCap UE and if initialDownlinkBWPRedcap (i.e., second initial DL BWP) is configured:

*****5> perform BWP switching to a BWP indicated by initialDownlinkBWPRedcap (i.e., second initial DL BWP);

****4> else (i.e., a UE is not a redcap OR a UE is Redcap but initialDownlinkBWPRedcap is not configured):

*****5> perform BWP switching to a BWP indicated by the initialDownlinkBWP (i.e., first initial DL BWP).

At least one of bwp-InactivityTimer, defaultDownlinkBWP-Id, dormantBWP-Id, initialDownlinkBWP and initialDownlinkBWPRedcap may be signaled by a base station (e.g., gNB) in an RRCReconfiguration message or system information.

Referring to FIG. 5, in operation 500, a UE may identify that bwp-InactivityTimer associated with an active DL BWP expires. In operation 502, the UE may identify whether defaultDownlinkBWP-Id is configured. If defaultDownlinkBWP-Id is configured, the UE may perform BWP switching to a BWP indicated by defaultDownlinkBWP-Id, in operation 504. If defaultDownlinkBWP-Id is not configured, the UE may identify whether the UE is a redcap UE and/or whether an initial downlink BWP for redcap UE (e.g., initialDownlinkBWPRedcap) is configured, in operation 506. Alternatively, the UE is a redcap UE and the UE may identify whether initialDownlinkBWPRedcap is configured, in operation 506. If the UE is a redcap UE and initialDownlinkBWPRedcap is configured, the UE may perform BWP switching to a BWP indicated by initialDownlinkBWPRedcap, in operation 508. If the UE is not a redcap UE or if the UE is a redcap UE but initialDownlinkBWPRedcap is not configured, the UE may perform BWP switching to a BWP indicated by initialDownlinkBWP, in operation 510.

It should be noted that the examples of FIGS. 4 and 5 as described above may be combined. For example, when a random access procedure is initiated, a UE may apply the example of FIG. 4 and then when a bwp inactivity timer has expired after the random access procedure is completed, the UE may apply the example of FIG. 5.

In one example of the present disclosure, a UE can be configured with a first and/or second initial UL BWP on NUL carrier. A UE can be configured with a first and/or second initial UL BWP on SUL carrier. A UE can be configured with a first and/or second initial DL BWP. The first initial UL BWP on a carrier and first initial DL BWP is for non-RedCap UEs. The second initial UL on a carrier and second initial DL BWP is for RedCap UEs. A RedCap UE is the UE which supports reduced number of UE RX/TX antennas, reduced bandwidth, relaxed UE processing time, relaxed UE processing capability, reduced maximum number of DL MIMO layers, relaxed maximum modulation order, relaxed Duplex operation, etc. The first initial UL BWP can be indicated by a field initialUplinkBWP in an RRCReconfiguration message or system information. The second initial UL BWP can be indicated by field initialUplinkBWPRedcap in RRCReconfiguration message or system information. The second initial UL BWP can also be indicated by another name. The first initial DL BWP can be indicated by a field initialDownlinkBWP in an RRCReconfiguration message or system information. The second initial DL BWP can be indicated by a field initialDownlinkBWPRedcap in an RRCReconfiguration message or system information.

A UE receives firstActiveDownlinkBWP-Id in configuration of one or more serving cell(s) in RRCReconfigurtaion message. If a firstActiveDownlinkBWP-Id is configured for an SpCell, this field contains the ID of the DL BWP to be activated upon performing the RRC (re-)configuration.

If the firstActiveDownlinkBWP-Id is configured for an SCell, this field contains the ID of the downlink bandwidth part to be used upon activation of an SCell. The initial bandwidth part is referred to by BWP-Id=0.

If the firstActiveDownlinkBWP-Id is set to 0 for a serving cell, a UE determines the DL BWP to be activated upon performing the RRC (re-)configuration if the serving cell is SpCell or downlink bandwidth part to be used upon activation of an SCell if the serving cell is SCell as follows:
if a UE is redcap UE and initialDownlinkBWPRedcap (i.e., second initial DL BWP) is configured:
   the firstActiveDownlinkBWP-Id set to 0 indicates initialDownlinkBWPRedcap (i.e., second initial DL BWP)
Else
   the firstActiveDownlinkBWP-Id set to 0 indicates initialDownlinkBWP (i.e., first initial DL BWP).

If the firstActiveUplinkBWP-Id is set to 0 for a serving cell, a UE determines the UL BWP to be activated upon performing the RRC (re-)configuration if the serving cell is SpCell or uplink bandwidth part to be used upon activation of an SCell if the serving cell is SCell as follows:
if a UE is a redcap UE and initialUplinkBWPRedcap (i.e., second initial UL BWP) is configured:
   the firstActiveUplinkBWP-Id set to 0 indicates initialUplinkBWPRedcap (i.e., second initial UL BWP)
Else
   the firstActiveUplinkBWP-Id set to 0 indicates initialUplinkBWP (i.e., first initial UL BWP)

*1> if an SCell is configured with sCellState set to be activated upon SCell configuration, or an SCell Activation/Deactivation MAC CE is received activating the SCell:

**2> if the SCell was deactivated prior to receiving this SCell Activation/Deactivation MAC CE; or

**2> if the SCell is configured with sCellState set to be activated upon SCell configuration:

***3> activate the SCell.

In one example of the present disclosure, a UE can be configured with a first and/or second initial UL BWP on NUL carrier. A UE can be configured with a first and/or second initial UL BWP on SUL carrier. A UE can be configured with a first and/or second initial DL BWP. The first initial UL BWP on a carrier and first initial DL BWP is for non-RedCap UEs. The second initial UL on a carrier and second initial DL BWP is for RedCap UEs. A RedCap UE is the UE which supports reduced number of UE RX/TX antennas, reduced bandwidth, relaxed UE processing time, relaxed UE processing capability, reduced maximum number of DL M IMO layers, relaxed maximum modulation order, relaxed Duplex operation, etc. The first initial UL BWP can be indicated by a field initialUplinkBWP in an RRCReconfiguration message or system information. The second initial UL BWP can be indicated by a field initialUplinkBWPRedcap in an RRCReconfiguration message or system information. The second initial UL BWP can also be indicated by another name. The first initial DL BWP can be indicated by a field initialDownlinkBWP in an RRCReconfiguration message or system information. Second initial DL BWP can be indicated by field initialDownlinkBWPRedcap in RRCReconfiguration message or system information.

A UE is in RRC_CONNECTED state.

A UE receives RRCReconfiguration message from a gNB.

An RRCReconfiguration message includes configuration of SCell.
The configuration of SCell includes firstActiveUplinkBWP-Id and firstActiveDownlinkBWP-Id.
a firstActiveUplinkBWP-Id is set to 0.
a firstActiveDownlinkBWP-Id is set to 0.
The sCellState is set to be activated in the configuration of SCell.

Upon receiving the SCell configuration with sCellState set to be activated:
a UE activates the SCell
if a UE is a redcap UE and initialUplinkBWPRedcap (i.e., second initial UL BWP) is configured for this SCell:
   a firstActiveUplinkBWP-Id set to 0 indicates initialUplinkBWPRedcap (i.e., second initial UL BWP);
   a UE uses the BWP (i.e., activates the BWP) indicated by initialUplinkBWPRedcap (i.e., second initial UL BWP) upon activation of SCell;
Else (i.e., a UE is not a redcap UE or a UE is a redcap UE but the initialUplinkBWPRedcap (i.e., second initial UL BWP) is not configured);
   a firstActiveUplinkBWP-Id set to 0 indicates initialUplinkBWP (i.e., first initial UL BWP);
   a UE uses the BWP (i.e., activates the BWP) indicated by initialUplinkBWP (i.e., first initial UL BWP) upon activation of SCell;
if a UE is a redcap UE and initialDownlinkBWPRedcap (i.e., second initial DL BWP) is configured for this SCell:
   a firstActiveDownlinkBWP-Id set to 0 indicates initialDownlinkBWPRedcap (i.e., second initial DL BWP);
   a UE uses the BWP (i.e., activates the BWP) indicated by initialDownlinkBWPRedcap (i.e., second initial DL BWP) upon activation of SCell;
Else (i.e., a UE is not a redcap UE or a UE is a redcap UE but the initialDownlinkBWPRedcap (i.e., second initial DL BWP) is not configured):
   a firstActiveDownlinkBWP-Id set to 0 indicates initialDownlinkBWP (i.e., first initial DL BWP);
   a UE uses the BWP (i.e., activates the BWP) indicated by initialDownlinkBWP (i.e., first initial DL BWP) upon activation of SCell.

In one example of the present disclosure, a UE can be configured with a first and/or second initial UL BWP on NUL carrier. A UE can be configured with a first and/or second initial UL BWP on SUL carrier. A UE can be configured with a first and/or second initial DL BWP. The first initial UL BWP on a carrier and first initial DL BWP is for non-RedCap UEs. The second initial UL on a carrier and second initial DL BWP is for RedCap UEs. A RedCap UE is the UE which supports reduced number of UE RX/TX antennas, reduced bandwidth, relaxed UE processing time, relaxed UE processing capability, reduced maximum number of DL MIMO layers, relaxed maximum modulation order, relaxed Duplex operation, etc. The first initial UL BWP can be indicated by a field initialUplinkBWP in an RRCReconfiguration message or system information. The second initial UL BWP can be indicated by a field initialUplinkBWPRedcap in an RRCReconfiguration message or system information. The second initial UL BWP can also be indicated by another name. The first initial DL BWP can be indicated by a field initialDownlinkBWP in an RRCReconfiguration message or system information. The second initial DL BWP can be indicated by a field initialDownlinkBWPRedcap in RRCReconfiguration message or system information.

A UE is in RRC_CONNECTED state.

A UE receives RRCReconfiguration message from a gNB.

An RRCReconfiguration message includes configuration of SCell.
The configuration of SCell includes firstActiveUplinkBWP-Id and firstActiveDownlinkBWP-Id.
a firstActiveUplinkBWP-Id is set to 0.
a firstActiveDownlinkBWP-Id is set to 0.
The sCellState is set to be deactivated in the configuration of SCell.

A UE receives SCell activation/deactivation MAC CE from a gNB activating the SCell.

Upon receiving SCell activation/deactivation MAC CE activating the SCell:
A UE activates the SCell.
if a UE is a redcap UE and initialUplinkBWPRedcap (i.e., second initial UL BWP) is configured for this SCell:
   a firstActiveUplinkBWP-Id set to 0 indicates initialUplinkBWPRedcap (i.e., second initial UL BWP); and
   a UE uses the BWP (i.e., activates the BWP) indicated by initialUplinkBWPRedcap (i.e., second initial UL BWP) upon activation of SCell;
Else (i.e., a UE is not a redcap UE or a UE is a redcap UE but the initialUplinkBWPRedcap (i.e., second initial UL BWP) is not configured):
   a firstActiveUplinkBWP-Id set to 0 indicates initialUplinkBWP (i.e., first initial UL BWP); and
   a UE uses the BWP (i.e., activates the BWP) indicated by initialUplinkBWP (i.e., first initial UL BWP) upon activation of SCell.
if a UE is a redcap UE and initialDownlinkBWPRedcap (i.e., second initial DL BWP) is configured for this SCell:
   a firstActiveDownlinkBWP-Id set to 0 indicates initialDownlinkBWPRedcap (i.e., second initial DL BWP); and
   a UE uses the BWP (i.e., activates the BWP) indicated by initialDownlinkBWPRedcap (i.e., second initial DL BWP) upon activation of SCell.
Else (i.e., a UE is not a redcap UE or a UE is a redcap UE but the initialDownlinkBWPRedcap (i.e., second initial DL BWP) is not configured):
   a firstActiveDownlinkBWP-Id set to 0 indicates initialDownlinkBWP (i.e., first initial DL BWP); and
   a UE uses the BWP (i.e., activates the BWP) indicated by initialDownlinkBWP (i.e., first initial DL BWP) upon activation of SCell.

In one example of the present disclosure, a UE can be configured with a first and/or second initial UL BWP on NUL carrier. A UE can be configured with a first and/or second initial UL BWP on SUL carrier. A UE can be configured with a first and/or second initial DL BWP. The first initial UL BWP on a carrier and first initial DL BWP is for non-RedCap UEs. The second initial UL on a carrier and second initial DL BWP is for RedCap UEs. A RedCap UE is the UE which supports reduced number of UE RX/TX antennas, reduced bandwidth, relaxed UE processing time, relaxed UE processing capability, reduced maximum number of DL MIMO layers, relaxed maximum modulation order, relaxed duplex operation, etc. The first initial UL BWP can be indicated by field initialUplinkBWP in RRCReconfiguration message or system information. The second initial UL BWP can be indicated by a field initialUplinkBWPRedcap in an RRCReconfiguration message or system information. The second initial UL BWP can also be indicated by another name. The first initial DL BWP can be indicated by a field initialDownlinkBWP in an RRCReconfiguration message or system information. The second initial DL BWP can be indicated by field initialDownlinkBWPRedcap in RRCReconfiguration message or system information.

A UE is in RRC_CONNECTED state.

A UE receives a first RRCReconfiguration message from a gNB upon entering the RRC_CONNECTED state.

A first RRCReconfiguration message includes configuration of SpCell.
The configuration of SpCell includes firstActiveUplinkBWP-Id and firstActiveDownlinkBWP-Id.
a firstActiveUplinkBWP-Id is set to non-zero BWP ID.
a firstActiveDownlinkBWP-Id is set to non-zero BWP ID.

A UE activates the DL BWP with BWP ID indicated by firstActiveDownlinkBWP-Id. A UE activates the UL BWP with BWP ID indicated by firstActiveUplinkBWP-Id.

A UE receives a second RRCReconfiguration message including configuration of SpCell.
The configuration of SpCell includes firstActiveUplinkBWP-Id and firstActiveDownlinkBWP-Id.
a firstActiveUplinkBWP-Id is set to 0.
a firstActiveDownlinkBWP-Id is set 0.

Upon receiving the second RRCReconfiguration message.
If a UE is a redcap UE and initialUplinkBWPRedcap (i.e., second initial UL BWP) is configured for this SpCell:
   a firstActiveUplinkBWP-Id set to 0 indicates initialUplinkBWPRedcap (i.e., second initial UL BWP); and
   a UE switches the active UL BWP to BWP indicated by initialUplinkBWPRedcap (i.e., second initial UL BWP).
Else (i.e., a UE is not a redcap UE or a UE is a redcap UE but the initialUplinkBWPRedcap (i.e., second initial UL BWP) is not configured).
   a firstActiveUplinkBWP-Id set to 0 indicates initialUplinkBWP (i.e., first initial UL BWP); and
   a UE switches the active UL BWP to BWP indicated by initialUplinkBWP (i.e., first initial UL BWP).
If a UE is a redcap UE and initialDownlinkBWPRedcap (i.e., second initial DL BWP) is configured for this SpCell:
   a firstActiveDownlinkBWP-Id set to 0 indicates initialDownlinkBWPRedcap (i.e., second initial DL BWP); and
   a UE switches the active UL BWP to BWP indicated by initialDownlinkBWPRedcap (i.e., second initial DL BWP).
Else (i.e., a UE is not a redcap UE or a UE is a redcap UE but the initialDownlinkBWPRedcap (i.e., second initial DL BWP) is not configured):
   a firstActiveDownlinkBWP-Id set to 0 indicates initialDownlinkBWP (i.e., first initial DL BWP); and
   a UE switches the active UL BWP to BWP indicated by initialDownlinkBWP (i.e., first initial DL BWP).

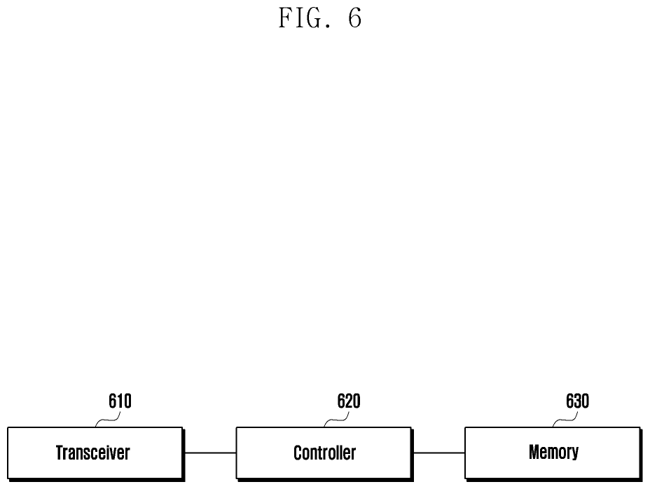

FIG. 6 illustrates a block diagram of a terminal according to various embodiments of the present disclosure.

Referring to FIG. 6, a terminal includes a transceiver 610, a controller 620 and a memory 630. The controller 620 may refer to a circuitry, an application-specific integrated circuit (ASIC), or at least one processor. The transceiver 610, the controller 620 and the memory 630 are configured to perform the operations of the UE illustrated in the figures, e.g., FIGS. 1-5, or described above. Although the transceiver 610, the controller 620 and the memory 630 are shown as separate entities, they may be realized as a single entity like a single chip. Or the transceiver 610, the controller 620 and the memory 630 may be electrically connected to or coupled with each other.

The transceiver 610 may transmit and receive signals to and from other network entities, e.g., a base station.

The controller 620 may control the UE to perform functions according to one of the embodiments described above.

For example, the controller 620 is configured to identify that a random access procedure is initiated on a serving cell, select a UL carrier for the serving cell, in case that PRACH occasions are not configured for an active UL BWP of the selected UL carrier, identify whether an initial UL BWP for a RedCap UE is configured, and in case that the initial UL BWP for the RedCap UE is configured, switch the active UL BWP to the initial UL BWP for the RedCap UE.

In an embodiment, the operations of the terminal may be implemented using the memory 630 storing corresponding program codes. Specifically, the terminal may be equipped with the memory 630 to store program codes implementing desired operations. To perform the desired operations, the controller 620 may read and execute the program codes stored in the memory 630 by using a processor or a central processing unit (CPU).

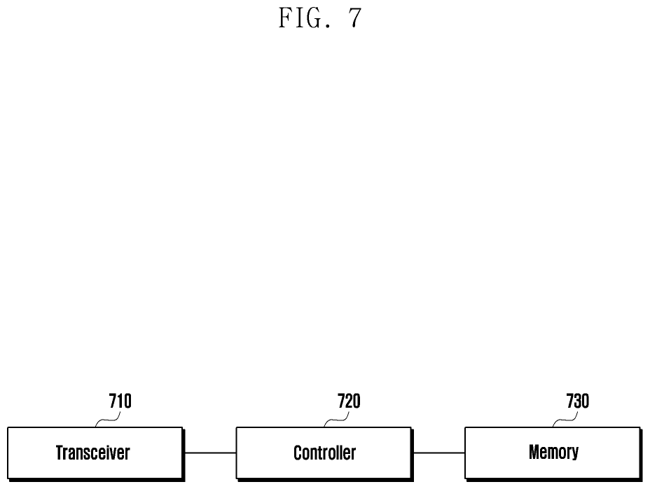

FIG. 7 illustrates a block diagram of a base station according to various embodiments of the present disclosure.

Referring to FIG. 7, a base station includes a transceiver 710, a controller 720 and a memory 730. The transceiver 710, the controller 720 and the memory 730 are configured to perform the operations of the network (e.g., gNB) illustrated in the figures, e.g., FIGS. 1 to 5, or described above. Although the transceiver 710, the controller 720 and the memory 730 are shown as separate entities, they may be realized as a single entity like a single chip. The transceiver 710, the controller 720 and the memory 730 may be electrically connected to or coupled with each other.

The transceiver 710 may transmit and receive signals to and from other network entities, e.g., a terminal.

The controller 720 may control the base station to perform functions according to one of the embodiments described above. The controller 720 may refer to a circuitry, an ASIC, or at least one processor.

In an embodiment, the operations of the base station may be implemented using the memory 730 storing corresponding program codes. Specifically, the base station may be equipped with the memory 730 to store program codes implementing desired operations. To perform the desired operations, the controller 720 may read and execute the program codes stored in the memory 730 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
identifying that a random access procedure is initiated on a serving cell;
selecting an uplink (UL) carrier for the serving cell;
in case that physical random access channel (PRACH) occasions are not configured for an active UL bandwidth part (BWP) of the selected UL carrier, identifying whether an initial UL BWP for a reduced capability (RedCap) UE is configured; and
in case that the initial UL BWP for the RedCap UE is configured, switching the active UL BWP to the initial UL BWP for the RedCap UE.

2. The method of claim 1, further comprising:
in case that the initial UL BWP for the RedCap UE is not configured, switching the active UL BWP to an initial UL BWP for a normal UE.

3. The method of claim 1, further comprising:
in case that the PRACH occasions are not configured for the active UL BWP of the selected UL carrier, identifying whether the serving cell is a special cell (SpCell);
in case that the serving cell is the SpCell, identifying whether an initial downlink (DL) BWP for the RedCap UE is configured; and
in case that the initial DL BWP for the RedCap UE is configured, switching an active DL BWP to the initial DL BWP for the RedCap UE.

4. The method of claim 3, further comprising:
in case that the initial DL BWP for the RedCap UE is not configured, switching the active DL BWP to an initial DL BWP for a normal UE.

5. The method of claim 1, further comprising:
in case that a BWP inactivity timer associated with an active downlink (DL) BWP expires, identifying whether a default DL BWP is configured;
in case that the default DL BWP is not configured, identifying whether an initial DL BWP for the RedCap UE is configured; and
in case that the initial DL BWP for the RedCap UE is configured, switching the active DL BWP to the initial DL BWP for the RedCap UE.

6. The method of claim 5, further comprising:
in case that the initial DL BWP for the RedCap UE is not configured, switching the active DL BWP to an initial DL BWP for a normal UE.

7. The method of claim 1, wherein the UE is a RedCap UE.

8. A user equipment (UE) in a wireless communication system, the UE comprising:
a transceiver; and
a controller operably connected to the transceiver, the controller configured to:
identify that a random access procedure is initiated on a serving cell,
select an uplink (UL) carrier for the serving cell,
in case that physical random access channel (PRACH) occasions are not configured for an active UL bandwidth part (BWP) of the selected UL carrier, identify whether an initial UL BWP for a reduced capability (RedCap) UE is configured, and
in case that the initial UL BWP for the RedCap UE is configured, switch the active UL BWP to the initial UL BWP for the RedCap UE.

9. The UE of claim 8, wherein the controller is further configured to:
in case that the initial UL BWP for the RedCap UE is not configured, switch the active UL BWP to an initial UL BWP for a normal UE.

10. The UE of claim 8, wherein the controller is further configured to:
in case that the PRACH occasions are not configured for the active UL BWP of the selected UL carrier, identify whether the serving cell is a special cell (SpCell),
in case that the serving cell is the SpCell, identify whether an initial downlink (DL) BWP for the RedCap UE is configured, and
in case that the initial DL BWP for the RedCap UE is configured, switch an active DL BWP to the initial DL BWP for the RedCap UE.

11. The UE of claim 10, wherein the controller is further configured to:
in case that the initial DL BWP for the RedCap UE is not configured, switch the active DL BWP to an initial DL BWP for a normal UE.

12. The UE of claim 8, wherein the controller is further configured to:
in case that a BWP inactivity timer associated with an active downlink (DL) BWP expires, identify whether a default DL BWP is configured,
in case that the default DL BWP is not configured, identify whether an initial DL BWP for the RedCap UE is configured, and
in case that the initial DL BWP for the RedCap UE is configured, switch the active DL BWP to the initial DL BWP for the RedCap UE.

13. The UE of claim 12, wherein the controller is further configured to:
in case that the initial DL BWP for the RedCap UE is not configured, switch the active DL BWP to an initial DL BWP for a normal UE.

14. The UE of claim 8, wherein the UE is a RedCap UE.
